(19) United States
(12) Patent Application Publication
(10) Pub. No.: US 2003/0015374 A1
(43) Pub. Date: Jan. 23, 2003

(54) Rotational-part supporter

(76) Inventors: Yasumaro Matsuura, Fukui (JP); Kikuta Yamada, Fukui (JP); Seiji Tanaka, Fukui (JP)

Correspondence Address: Richard M. Goldberg, Suite 419, 25 East Salem Street, Hackensack, NJ, 07601, US

(21) Appl. No.: 10/107,791

(22) Filed: Mar. 27, 2002

(30) Foreign Application Priority Data
Jul. 19, 2001 (JP) 220065/2001

(51) Int. Cl. F16N 27/00

(52) U.S. Cl. 184/7.4

(57) ABSTRACT

The invention provides a rotational-part supporter in which one of either an inner part or an outer part is fixed, and the other one is rotated, and a main rotational shaft lies between the inner and outer parts. A number of revolutions below a set number of revolutions based on a lubrication lifetime predicted for each rotational bearing (3) is stored in a memory (61) disposed in a lubricant supply controller (6). When the number of revolutions obtained by actual rotation reaches the stored number of revolutions in the rotational bearing (3) after supplying a lubricant, the controller (6) issues a signal indicating that a lubricant should be newly supplied, and thereby a safe operation can be realized.

### BACKGROUND OF THE INVENTION

This invention relates to a structure in which a supply method for a lubricant, such as grease, has been improved in a rotational-part supporter.

Generally, in a rotational-part supporter, one of either an inner part or an outer part is fixed, and the other one is rotated, and a rotational bearing that has a roller lies between the inner and outer parts.

As methods for lubricating the rotational bearing, various methods, such as grease lubrication, oil mist lubrication, and jet lubrication, are employed. The grease lubrication is lower in the conformability to a high number of revolutions than the other lubricating methods, but, is characterized by its inexpensive raw materials, by low heat generation, and by a slight influence on the surrounding environment. Therefore, in recent years, revaluation has been again placed on the grease lubrication.

Usually, in grease lubrication, the lubrication lifetime of a rotational bearing depends on a Dmn value (Diameter of medium & number of rotations), i.e., (average diameter of a rotational bearing) X (number of revolutions per minute). For example, in a bearing that uses a cylindrical roller, an empirical fact shows that the lubrication lifetime of the rotational bearing is about 20,000 hours if the Dmn value is about 600,000, and is about 5000 hours if the Dmn value is one million on the supposition that the rotational bearing is continuously rotated.

This empirical fact means that the time to maintain a lubricating function in the rotational bearing is shortened as the circumferential speed of the roller increases. However, the conventional lubricant supply has been carried out on the basis of sense and experience in the field, and rules/notions about regular lubricant supply according to a fixed standard have not been advanced so far.

For this reason, not a few cases occur in which the lubrication lifetime of the rotational bearing has passed, and, as a result, fatigue of the bearing or breakage in the rotational-part supporter sometimes occurs.

The present invention has been made in consideration of the above-mentioned circumstances of the conventional technique, and aims to provide a structure of a rotational-part supporter capable of regularly supplying a lubricant at a preliminary step toward the end of the lubrication lifetime of a rotational bearing.

### SUMMARY OF THE INVENTION

In order to achieve the object, a rotational-part supporter in which one of either inner or outer parts is fixed, and the other one is rotated, and a main rotational shaft lies between the inner and outer parts, according to the present invention is characterized in that a number of revolutions below a set number of revolutions based on a predicted lubrication lifetime of each rotational bearing is stored in a memory disposed in a lubricant supply controller, and, if the number of revolutions obtained by actual rotation of the rotational bearing reaches the stored number of revolutions after a lubricant is supplied to the rotational bearing, the controller issues a signal indicating that a lubricant should be again supplied.

### BRIEF DESCRIPTION OF THE DRAWINGS

FIG. 1 is a side sectional view of a rotational bearing, a lubricant supply pump, and a block diagram of a controller for showing the basic structure of the present invention, in which (a) is a case in which a rotor is disposed at the inner part, and (b) is a case in which the rotor is disposed at the outer part.

FIG. 2 is a flowchart for explaining the working principle of the present invention.

FIG. 3 is a side view showing a track oil groove formed in an outer rotational ring.

FIG. 4 is a side view showing a track oil groove formed in an inner fixed ring.

FIG. 5 shows various types of sectional shapes of the track oil groove.

FIG. 6 is a sectional view for explaining a state of an inner rotational ring, an outer rotational ring, and a track oil groove in each rotational ring when a spherical roller is used.

FIG. 7 is a sectional view for explaining a state of the inner rotational ring, the outer rotational ring, and the track oil groove in each rotational ring when the spherical roller is used.

FIG. 8 is a sectional view for explaining a state of the inner rotational ring, the outer rotational ring, and the track oil groove in each rotational ring when the spherical roller is used.

### DETAILED DESCRIPTION OF THE INVENTION

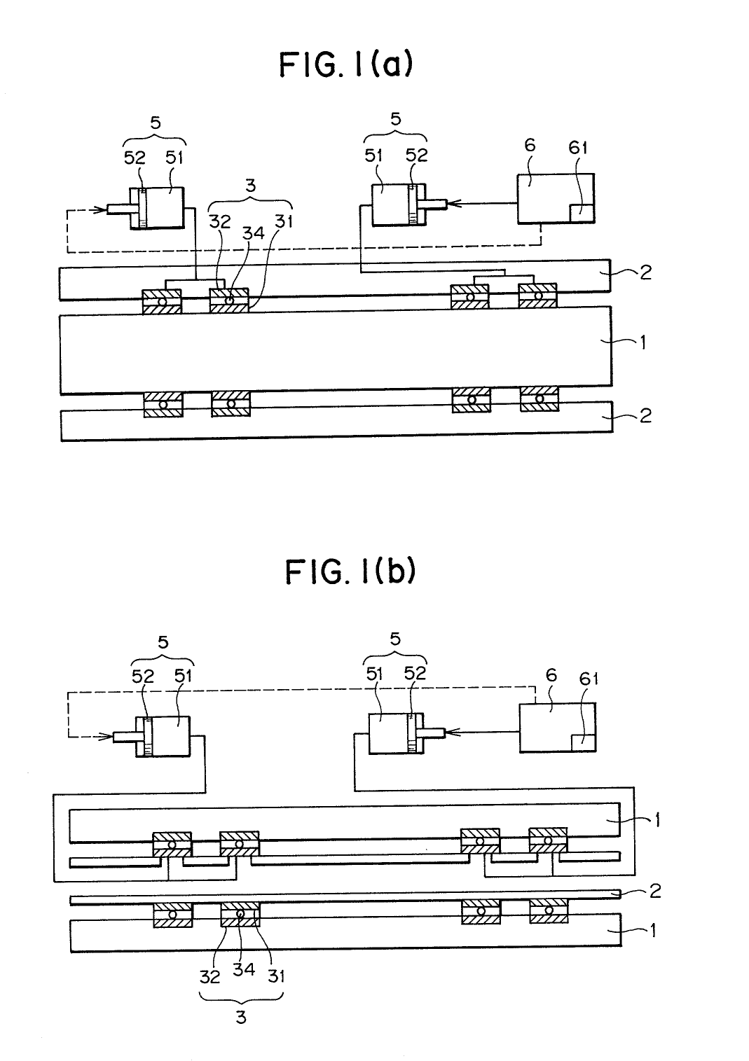

As shown in FIG. 1, both in a case where a rotational-part supporter ((a) of FIG. 1) includes a stator 2 of an outer part and a rotor 1 of an inner part and in a case where a rotational-part supporter ((b) of FIG. 1) includes the rotor 1 of the outer part and the stator 2 of the inner part, the rotational-part supporter is constructed by disposing a rotational bearing 3 between the inner and outer parts.

As described above, a lubrication lifetime according to each lubrication method depends on Dmn values that reflect the rotational speed of the rotational bearing 3, and a lubrication lifetime corresponding to each Dmn value is roughly known by past experience or statistics.

The lubrication lifetime that corresponds to each Dmn value and that is specified by time is based on the fact that the rotational-part supporter is continuously used.

However, in practice, the rotational-part supporter is not continuously used, and the time to supply a lubricant depends on the frequency of use of the rotational-part supporter.

If the rotational speed is constant, the number of revolutions of the rotational-part supporter and the rotating time are in definite proportionality. This fact is not influenced by whether the rotational-part supporter is continuously rotated or not.

Therefore, from the relationship between the Dmn value and the lubrication lifetime, the larger the Dmn value is, the smaller the number of revolutions that ends the lubrication lifetime of a lubricant is.

The present invention that has been made in consideration of these circumstances is basically characterized in the following respect. A numerical value below a number of revolutions based on statistical data about the lubrication lifetime of a lubricant is preset in accordance with each type of rotational-part supporter classified by various Dmn values based on an average diameter (i.e., the sum average of outer and inner diameters) of the rotational bearing 3, a rotational speed, etc. The numerical value is then stored in a memory 61 disposed in the lubricant supply controller 6, and, when the rotational-part supporter reaches the state of the set value, a signal to supply a lubricant is issued.

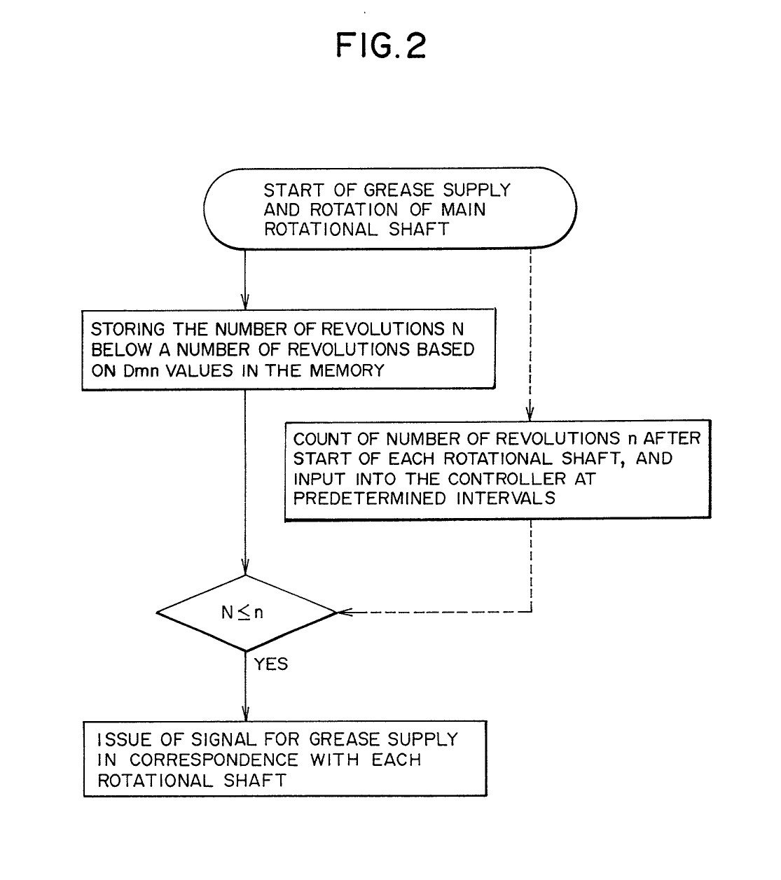

This control process can be expressed by the flowchart of FIG. 2.

Usually, a microcomputer or a dedicated digital counter circuit can transmit the signal based on the set value stored in the memory 61. When this signal is issued, a piston 52 of a lubrication pump 5 is operated manually or automatically, thus supplying the lubricant to the rotational bearing 3, as shown in (a) and (b) of FIG. 1.

However, dependent upon the gist of the present invention that aims to regularly supply a lubricant, it is preferable to have a structure capable of automatically supplying a lubricant to a rotational shaft on the basis of the above-mentioned signal.

Like the rotational bearing 3 usually used, a rotational bearing of the present invention has a structure in which a track oil groove 4 is formed both in a rotational ring 31 and in a fixed ring 32, and a lubricant supplied from the lubrication pump 5 along the oil groove 4 is gathered and brought into contact with the rotational surface of the ball 34 or the cylindrical roller 33 of the ball bearing, thus performing a lubricating action on the rotation.

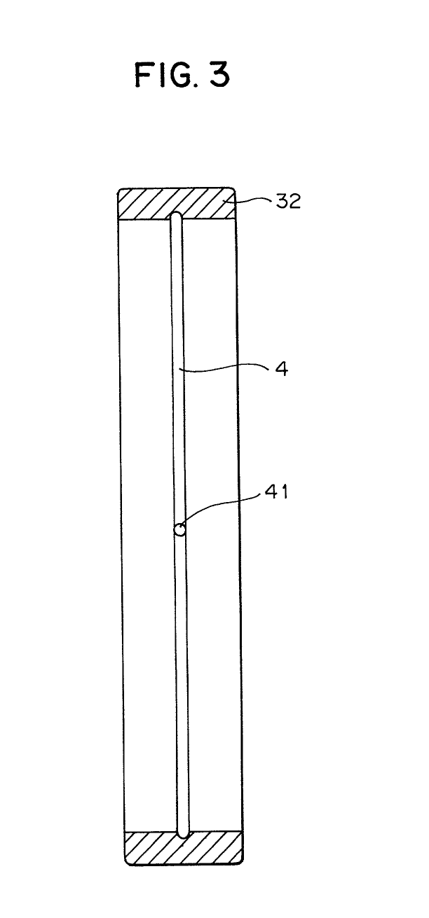

FIG. 3 shows a track oil groove 4 of, for example, a fixed ring 32 integral with the fixed outer part and a rotational ring 31 integral with the rotating inner part. The oil groove 4 is formed at the circumference of the fixed ring 32 and in that of the rotational ring 31.

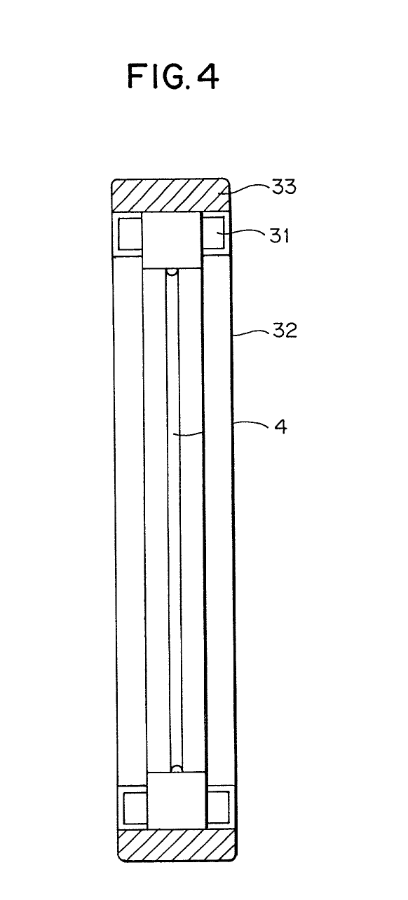

However, the track shape of the oil groove 4 is not limited to a linear one along the circumference as shown in FIG. 3 and FIG. 4, and can be designed to have various shapes, such as a spiral, screw, or cross made by the intersection of two slanted/straight lines.

Even if the relationship between the inner and outer parts of the rotational ring 31 and fixed rings 32 is reversed from the design shown in FIG. 3 and FIG. 4, there is no change in that the oil groove 4 is formed in the circumferences of each fixed ring and each rotational ring.

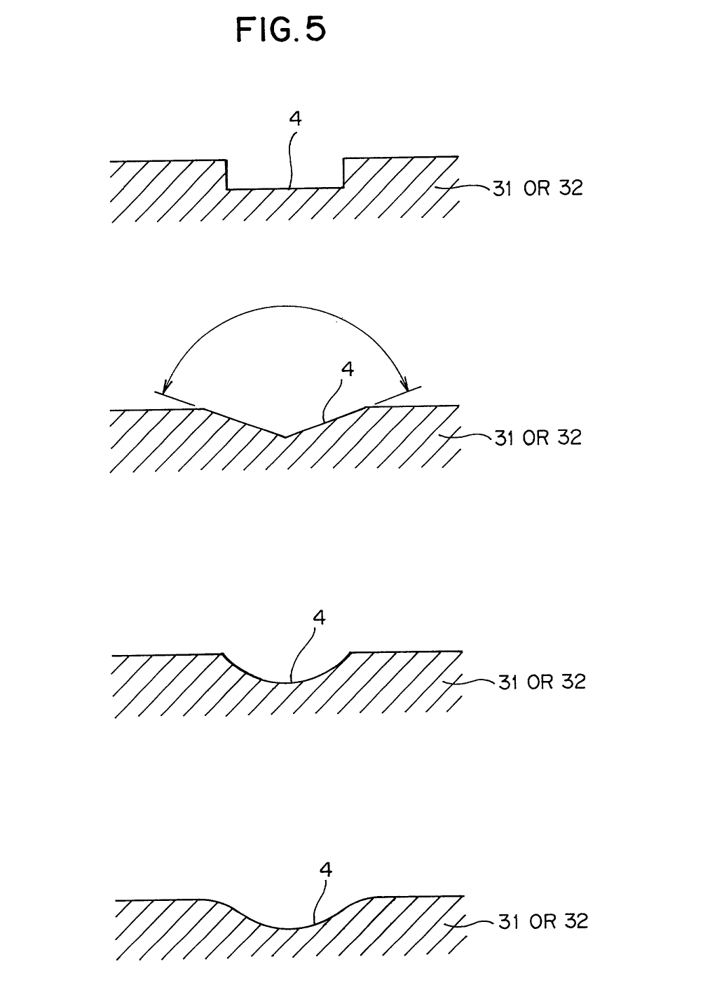

As shown in FIG. 5, the cross-sectional shape of the oil groove 4 can be formed to be substantially rectangular, substantially triangular, substantially arcuate, or a doubly arcuate shape in which an arcuate shape whose rotational center is the inner part at both sides is combined with an arcuate shape whose rotational center is the outer part therebetween. Accordingly, the cross-sectional shape is not limited to a specific shape.

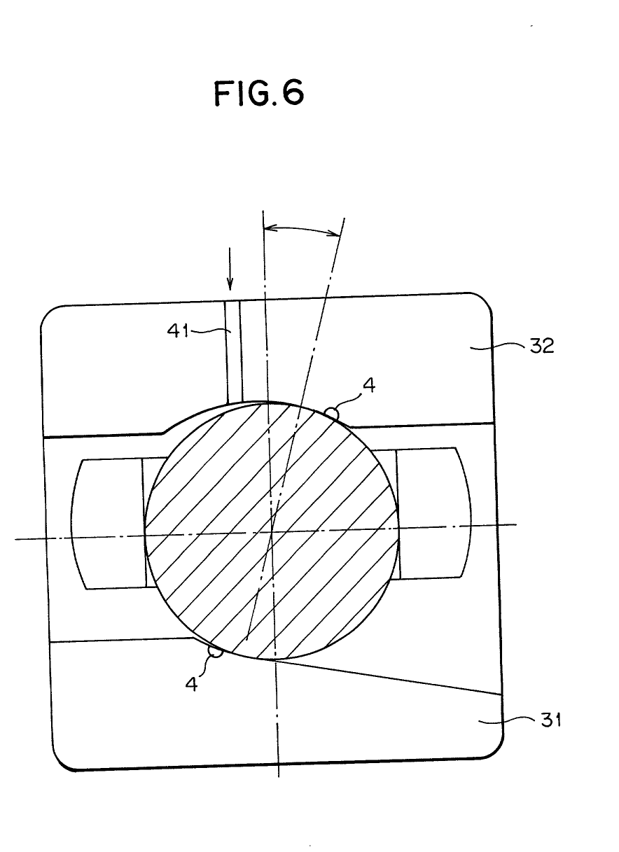

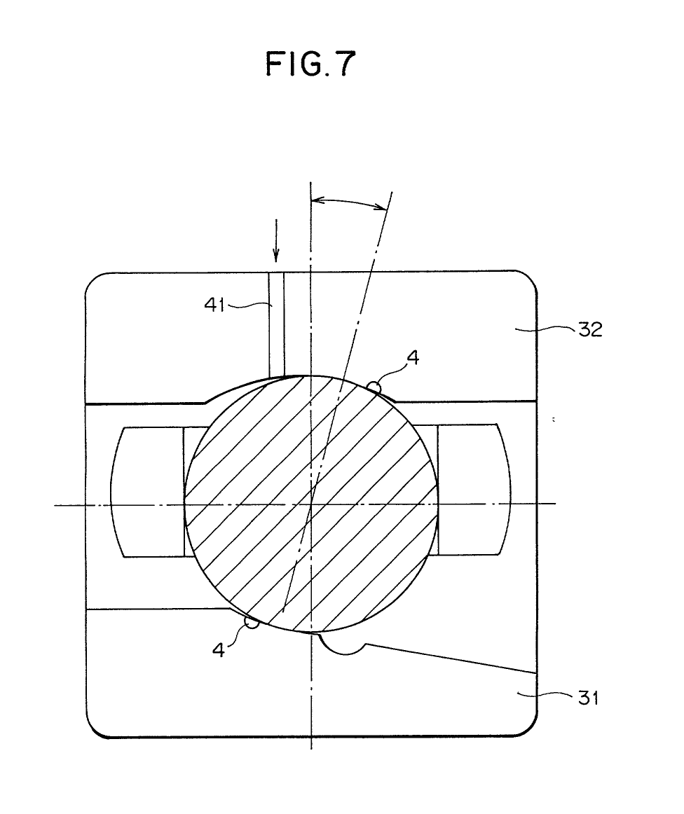

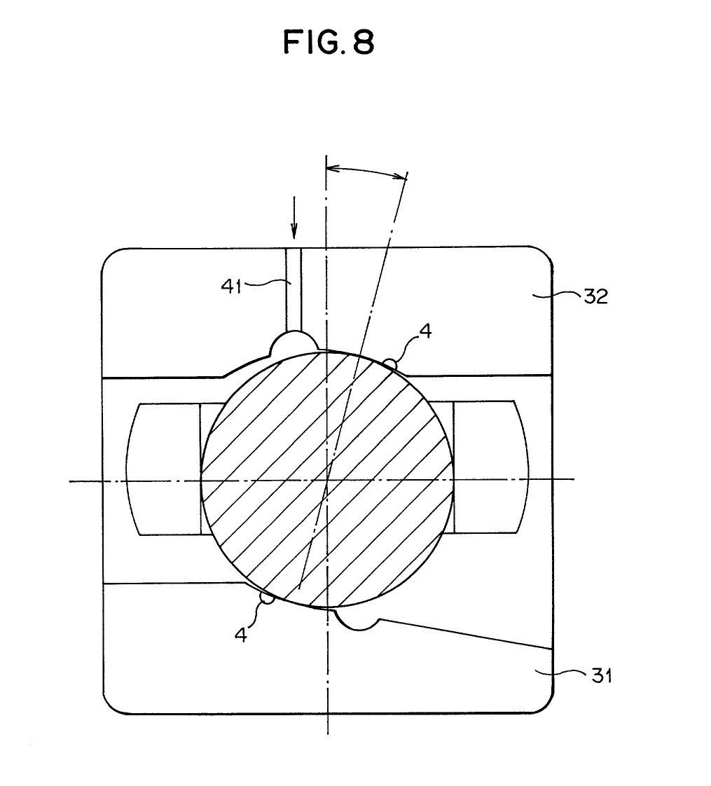

FIG. 6, FIG. 7, and FIG. 8 show the rotational ring 31 integral with the fixed outer part, the fixed ring 32 integral with the rotating inner part, and each track oil groove 4 in a case where a spherical roller 34 is especially used as a roller. In the spherical roller 34 of the ball bearing, it is essential to dispose the track oil groove 4 at a place other than the part where the spherical roller 34, the rotational ring 31, and the fixed ring 32 are rotated while contacting with each other.

Even if the inner and outer positions of the rotational ring 31 and the fixed ring 32 are reversed from the design shown in FIG.6, FIG.7, and FIG.8, there is no change in that it is essential to dispose the track oil groove 4 at a place other than the part where the spherical roller 34 is rotated while contacting with the outer rotational ring 31 and the inner fixed ring 32.

Embodiments

Embodiments of the present invention are hereinafter described.

Embodiment 1

A number of revolutions below a number of revolutions based on Dmn values of each type of rotational-part supporter is stored in the memory 61, and a signal to supply a lubricant is issued. Thereby, in most cases, the lubricant can be supplied to the rotational bearing 3 before the end of a lubrication lifetime.

However, exceptionally, there is a case where the rotational lifetime corresponding to the Dmn values is inappropriate for the rotational bearing 3 that is actually working, and the lubrication lifetime of the rotational bearing 3 is passed at a preliminary step toward the number of revolutions stored in the memory 61 of the lubricant supply controller 6.

In Embodiment 1, in this case, a numerical value below a number of revolutions corresponding to a rotation lifetime that has been newly obtained by actual use is stored in the memory 61 without dwelling on the number of revolutions based on past Dmn values, and a signal indicating that a lubricant should be newly supplied is issued on the basis of this number of revolutions.

By newly setting a number of revolutions in this way, it is possible to more reliably carry out the lubricant supply before the end of a lubrication lifetime that actually matches with the rotational bearing 3 used practicality.

Embodiment 2

FIG. 1 shows a form in which the NC controller 6 including the memory 61 that stores a set number of revolutions is provided to each individual main rotational shaft.

The design of one-to-one can be allowed, of course. In FIG. 1, it is possible to store different numbers of revolution, one of which corresponds to the ball 34 of the ball bearing at the front side and the other one corresponds to the cylindrical roller 33 at the rear side, and thereafter issues a corresponding signal.

However, the controller 6 including the memory 61 is not necessarily required to be disposed in accordance with the rotational-part supporter. For example, it is fully possible to store a number of revolutions that corresponds to each rotational bearing 3 of the rotational-part supporter in one memory 61 with respect to a plurality of rotational-part supporters in a factory, and issue a signal indicating that a lubricant should be individually supplied to each rotational bearing 3.

Embodiment 2 has a basic feature in that one memory 61 is provided to a plurality of rotational-part supporters in this way. This structure makes it possible to realize efficient design and control.

Effects of the Invention

In the present invention constructed as above, a lubricant can be sequentially supplied without waiting for the end of a lubrication lifetime of a lubricant. As a result, an accident due to the wear of a rotational bearing can be prevented, and the rotational bearing can be safely operated for a long time.

Especially, when the lubricant is automatically supplied in response to a signal, safe operations can be carried out without performing special labor, as described above. This is extremely convenient.

Thus, the present invention has a versatile advantage, and its value is great.

FIG. 2

1. Start of grease supply and rotation of main rotational shaft

2. Storing the number N of revolutions below a number of revolutions based on Dmn values in the memory

3. Count of number n of revolutions after start of each rotational shaft, and input into the controller at predetermined intervals

4. Issue of signal for grease supply in correspondence with each rotational shaft

FIG. 5

31 or 32

What is claimed is:

1. A rotational-part supporter comprising:
an inner part and an outer part, one of the inner part and the outer part is fixed, and the other of the inner part and the outer part is rotated,
a main rotational bearing lying between the inner part and the outer part, and
a lubricant supply controller including a memory for storing a number of revolutions of the rotational bearing below a set number of revolutions based on a lubrication lifetime predicted for each rotational bearing, said lubricant supply controller providing a lubrication signal to newly supply a lubricant to said bearing if the number of revolutions obtained by actual rotation reaches the stored number of revolutions of the rotational bearing after an initial lubricant is supplied thereto.

2. The rotational-part supporter of claim 1, further including a device for automatically supplying the lubricant on the basis of a lubrication signal.

3. The rotational-part supporter of claim 1, wherein the memory newly stores number of revolutions below a set number of revolutions corresponding to the known rotation lifetime of the rotational bearing which has become known before reaching the number of revolutions stored in the memory, and said lubricant supply controller issues a signal on the basis of the newly stored number of revolutions.

4. The rotational-part supporter of claim 1, wherein one said memory is provided for a plurality of rotational-part supporters, and numbers of revolution of a plurality of rotational bearings of said plurality of rotational-part supporters are stored in the memory.

5. The rotational-part supporter of claim 1, wherein the inner part and the outer part each have complementary oil track grooves for receiving the lubricant.

6. The rotational-part supporter of claim 5, wherein the oil track grooves each have a cross-sectional configuration selected from the group consisting of substantially rectangular, substantially triangular and substantially arcuate.

7. The rotational-part supporter of claim 1, wherein the oil track grooves have a circular configuration.

8. The rotational-part supporter of claim 1, wherein the inner and outer parts have bearing grooves for receiving the bearing therein, and the oil track grooves are positioned offset from positions where the bearing contacts the bearing grooves of the inner and outer parts.

9. The rotational-part supporter of claim 8, further comprising a lubricant supply bore in at least one of said inner part and outer part for supplying said lubricant to said bearing.

10. The rotational-part supporter of claim 1, wherein the bearing is spherical ball.
